(19) United States
(12) Patent Application Publication
(10) Pub. No.: US 2007/0109933 A1
(43) Pub. Date: May 17, 2007

(54) Recording position deviation correction apparatus, recording position deviation correction method, and recording position correction program

(76) Inventors: Yorikazu Takao, Osaka (JP); Tatsushi Hiraki, Osaka (JP)

Correspondence Address: MCDERMOTT WILL & EMERY LLP, 600 13TH STREET, NW, WASHINGTON, DC, 20005-3096, US

(21) Appl. No.: 10/583,372

(22) PCT Filed: Dec. 10, 2004
(86) PCT No.: PCT/JP04/18464

§ 371 Date: Jun. 19, 2006

(30) Foreign Application Priority Data
Dec. 17, 2003 (JP) 2003-419962

(51) Int. Cl. G11B 19/00

(52) U.S. Cl. 369/47.47

(57) ABSTRACT

In the prior art recording position deviation correction apparatus, it was difficult to obtain the physical address position during performing an additional recording processing. So, a high reliability recording position deviation amount cannot be calculated, and the recording position deviation correction cannot be carried out correctly. The present invention adopts, as a calculating method for calculating the recording position deviation amount in the additional recording processing, one among (1) to perform an interpolation processing on the basis of the physical address position before performing an additional recording processing thereby to detect the physical address during performing the additional recording processing, and calculates the positional deviation amount using the detected physical address position, (2) to calculate the recording position deviation amount on the basis of the position deviation amount before performing the additional recording processing, and (3) to obtain the physical address position in a stationary state by making the laser power to be irradiated constant when obtaining the physical address in the recording processing, and calculate the recording position deviation amount using the obtained physical address position, and thereby realizes a high reliability recording position deviation correction.

### TECHNICAL FIELD

The present invention relates to a recording position correction apparatus, a recording position correction method, and a recording position correction program and, more particularly, to those which correct deviations in the recording positions when performing additional recording from a position which is successive to the data region on an optical disc where recording was already performed.

### BACKGROUND ART

Recently, optical discs which recordings of data therein such as DVD-RAM, DVD-R/RW, DVD+R/RW have been successively sold out, and have been used in various fields. Among those, DVD-RAM has recording areas for recording data which are divided in sector units, and divisional recording of recording data into discrete areas respectively is made possible. Meanwhile, when recording of data in DVD-R/RW and DVD+R/RW in which recording is once made is additionally made (this recording is called hereinafter as additional recording), the additional recording is performed from a region which is successive to an end position of the recorded region in the disc.

However, when performing this additional recording of data, the positional deviation may arise at the joint portion between the recorded region and the region where the additional recording is performed, thereby unfavorably influencing the recording and reproduction of the data.

More particularly, when the data recorded in a disc is reproduced, it is necessary to take a synchronization with a data unit that is determined in the decoding processing, and in order to satisfy the same, a synchronization signal is periodically inserted into the data before being reproduced. Then, if there has arisen a deviation in the position of the recorded data, there may be no detection or an error detection of the SYNC signal which results in incapability of reproduction of the recorded data. In order to avoid occurrence of such problem, it was an ideal that recorded data region and the additional recording region are perfectly continuous to each other. However, in the actual additional recording, a recording position deviation would unavoidably arise.

As a prior art technique to solve this problem of recording position deviation, there is a patent reference No. 1 (Japanese patent application No. 2001-245522). In this reference No. 1, the deviation between the physical address such as an LPP which is embedded in a disc and the SYNC position is measured during the additional recording, and the SYNC data is compressed in accordance with the direction of the deviation, thereby to correct the recording positional deviation arising accompanying the additional recording.

However, while in the technique of the recording position deviation correction in the reference No. 1, that the physical address is already detected is required as an assumption for its application since the positional deviation of the recording data is measured with taking the physical address such as an LPP which is embedded in the disc as a reference, the detection of the physical address having a high reliability in the additional recording processing is difficult because of the following reasons:

The first reason is as follows:

In the recording processing, the writing in into a disc is carried out by using a strong laser for recording a mark and a weak laser for recording a space separately. Therefore, when a space is recorded when passing the physical address position during the recording processing, the signal level of the physical address which is detected is unfavorably lowered accompanying with the intensity of the laser power which is irradiated to a disc, thereby it is difficult to detect the physical address with a high precision. Also this problem becomes obvious as the speed of the recording processing becomes multiple high speed. This is because the laser power at recording a space is decreased with relative to that at recording a mark as the speed at the recording processing becomes multiple high speed.

The second reason is as follows:

The timing immediately after starting the additional recording processing is immediately after changing the processing from the reproduction processing for searching the end position of the recorded region to the recording processing for additionally recording additional data. More particularly, it is immediately after the intensity of the laser light that is irradiated to the disc is changed from a predetermined laser intensity that is irradiated to the disc at the reproduction processing to a predetermined laser intensity that is irradiated to the disc at the recording processing. Then, such a state immediately after the start of the additional recording processing becomes a state where the detection of the physical address position is unstable and the detection of the physical address having a high reliability is very difficult. Thus, immediately after the start of the additional recording processing, particularly it becomes difficult in detecting the physical address position having a high reliability.

Since it is difficult to always detect the physical address having a high reliability in the additional processing as described in the above two reasons, it is not possible to accurately measure the recording position deviation that is detected with taking the physical address position as a reference, and therefore, even when the prior art recording position deviation correction technique is applied, it was not possible to carry out recording position deviation correction of a high precision.

The present invention is directed to solving such a problem and has its object to provide a recording position deviation correcting apparatus, a recording position deviation correcting method, and a recording position deviation correcting program which can detect the positional deviation amount by using the physical address position information having a high reliability even when performing the additional recording continuously to the data region on the disc where the recording is already performed, and thereby enables performing a high quality recording position deviation correction.
(Patent Reference No. 1) Patent application: 2001-245522

### DISCLOSURE OF THE INVENTION

In order to solve the above-described problems, a recording position deviation correction apparatus of the present invention performs an interpolation processing on the basis of the high reliability physical address which is detected before executing the additional recording processing, without detecting the physical address from an optical disc, to detect the physical address position which is used during the additional recording processing, at carrying out the additional recording processing which carries out recording of data continuously to the data region where the recording is already performed on an optical disc, and performs the recording position deviation correction at the additional recording processing, using the detected physical address position.

Thereby, since the physical address position during performing the additional recording processing is detected on the basis of the physical address position having a high reliability that is detected before the additional recording processing, a high reliability physical address position can be obtained even during performing the additional recording processing, and thereby a high quality recording position deviation correction can be realized using the same.

Further, a recording position deviation correction apparatus of the present invention includes a physical address position interval measuring section which measures the detection interval of the physical address position on the basis of the wobble signal which is recorded on an optical disc, while detecting the physical address position by an interpolation processing.

Thereby, utilizing the nature of the wobble signal that its period changes in accordance with the rotation speed of the optical disc and the period number for each physical address position interval is constant regardless of the rotation speed of the optical disc, it is possible to stably generate one sector period interval regardless of the speed of the disc, and thereby a high precision interpolation processing is enabled.

Further, a recording position deviation correction apparatus of the present invention includes a physical address position interval measuring section which measures the detection interval of the physical address position using a timer section.

Thereby, it is possible to measure the detection interval of the physical address position by the timer section, and thereby a high precision interpolation processing on the basis of the measured physical address position detection interval is enabled.

Further, the recording position deviation correction apparatus of the present invention calculates the recording position deviation amount at the final sector in the recorded region from the physical address position in the reproduction processing immediately before performing the additional recording processing and the sector top position corresponding thereto, without detecting the physical address position from a disc, and then perform the recording position deviation correction on the basis of the recording position deviation amount, at carrying out an additional recording processing which carries out recording continuously to the data region where the recording is already performed on an optical disc.

Thereby, it is possible to detect the recording position deviation amount at the final sector in the recorded region having a high reliability using the physical address which is detected in the reproduction processing immediately before the additional recording processing, and it is possible to carry out a high quality recording position deviation correction utilizing that the recording position deviation amount at the final sector in the recorded region and the positional deviation correction amount that is required to be corrected in the additional recording processing are approximately equal to each other.

Further, the recording position deviation correction apparatus of the present invention includes a laser control section which controls the laser output which is irradiated by an optical head so that data which has a high physical address detection probability at the reproduction are recorded irregardless of the data to be recorded at the physical address detection timing at the final several sectors within the recording processing range.

Thereby, it is possible to record data which has a high physical detection probability at the reproduction at the end of the recording processing range by the laser control section, and it is possible to enhance the reliability of the physical address position detection in the reproduction processing immediately before the additional recording processing, and therefore, the recording position deviation amount at the final sectors in the recorded region can be calculated with high precision, and a higher quality recording position deviation correction is carried out.

Further, the recording position deviation correction apparatus of the present invention includes a laser control section which controls the laser output which is irradiated by an optical head so that a laser which has a high physical address position detection probability is irradiated irregardless of the data to be recorded at the physical address detection timings during the recording processing.

Thereby, since the laser of a constant intensity is always irradiated at the physical address position detection timing during the recording processing, the reliability of physical address position detection by the physical address position detection section during performing the recording processing can be enhanced, and a high quality recording position deviation correction can be carried out.

Further, the recording position deviation correction apparatus of the present invention includes a physical address obtaining optical head which irradiates a constant power laser light which does not influence on the recording processing, prior to irradiating a laser light for performing a recording processing.

Thereby, since the detection of physical address position can be carried out from the reflection light against the laser power of a constant intensity which is irradiated from a physical address obtaining optical head, it is possible to obtain a high reliability physical address position, and possible to carry out a high quality recording position deviation correction.

### BRIEF DESCRIPTION OF THE DRAWINGS

FIG. 1 is a diagram illustrating a whole construction of an optical disc apparatus according to a first embodiment of the present invention.

FIG. 2 is a diagram explaining the interpolation processing of the physical address position by the physical address position interpolation section.

FIG. 3 is a flowchart illustrating the recording position deviation correction amount calculation algorism by the recording position deviation amount correction section in the first embodiment of the present invention.

FIG. 4 is a block diagram illustrating another construction of an optical disc device according to the first embodiment of the present invention.

FIG. 5 is a block diagram illustrating a whole construction of an optical disc apparatus according to a second embodiment of the present invention.

FIG. 6 is a flowchart illustrating a recording deviation correction amount calculation algorism by the recording position deviation correction control section according to the second embodiment of the present invention.

FIG. 7 is a block diagram illustrating a whole construction of an optical disc apparatus according to a third embodiment of the present invention.

FIG. 8 is a flowchart illustrating a laser control algorism by a laser control section according to the third embodiment of the present invention.

FIG. 9 is a block diagram illustrating a whole construction of an optical disc apparatus according to a fourth embodiment of the present invention.

FIG. 10 is a flowchart illustrating a laser control algorism by a laser control section according to the fourth embodiment of the present invention.

FIG. 11 is a block diagram illustrating a whole construction of an optical disc apparatus according to a fifth embodiment of the present invention.

### DESCRIPTION OF THE NUMERALS

100 optical disc
101, 201, 301, 401, 501 recording position deviation correction apparatus
102 spindle motor
103 optical head
104 modulation/de-modulation part
105 error correction/addition part
106 data buffer section
107 host interface section
108 host
109 physical address position detection section
110 physical address position storing section
111 physical address position interval measuring section
112 physical address position interpolation section
113 sector top address position detection section
114 403, 503 recording position deviation correction control section
115, 202, 403, 503 recording position deviation correction control section
116 timer section
202 sector top position storing section
302, 402 laser control section
502 physical address obtaining head

### BEST MODES EMBODING THE INVENTION

Hereinafter, embodiments of the present invention will be described with reference to the drawings.

### Embodiment 1

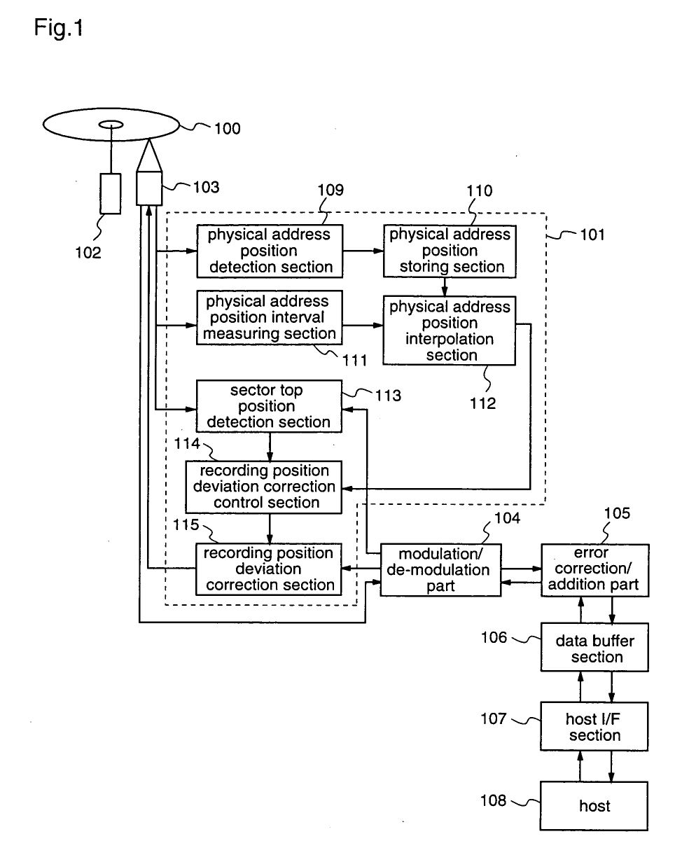

The recording position deviation correcting apparatus according to a first embodiment of the present invention functions to perform an interpolation processing on the basis of the physical address position which is detected before performing additional recording processing, without detecting the physical address position from a disc, to obtain the physical address position during performing the additional recording processing, at carrying out the additional recording processing which carries out recording of data continuously to the data region where the recording is already performed on an optical disc, and performs the recording position deviation correction in the additional recording processing, using the physical address. The content thereof will be described with reference to FIGS. 1 to 4.

FIG. 1 is a block diagram illustrating a whole construction of an optical disc apparatus according to the first embodiment of the present invention.

In FIG. 1, the optical disc apparatus of the first embodiment of the present invention includes a recoding position deviation correction apparatus 101, a spindle motor 102, an optical head 103, a modulation/demodulation section 104, an error correction/addition section 105, a data buffer section 106, and a host interface section 107, and a host 108.

The recording position deviation correction apparatus 101 performs an interpolation processing on the basis of the physical address position which is detected before performing the additional recording processing, without detecting the physical address from a disc, at carrying out the additional recording processing which carries out recording of data continuously to the data region where the recording is already performed on an optical disc 100 to detect the physical address position, and performs the recording position deviation correction in the additional recording processing from the detected physical address position and the sector top position of the recording and reproduction data.

The spindle motor 102 rotates the optical disc 100.

Further, the optical head 103 carries out recording and reproduction against the optical disc 103 by irradiating of a laser and receiving of the reflected light.

The modulation/demodulation section 104 modulates the data which is transmitted from the error correction/addition section 105 or demodulates the signal read out from the optical disc 100.

The error correction/addition section 105 performs correction of error data included in the data demodulated by the modulation/demodulation section 104 or adds error correction code to the recorded data stored in the data buffer section 106.

The data buffer section 106 stores the recording or reproduced data temporary and the host I/F section 107 communicates the recording data or reproduced data with the host 108 such as a computer.

Next, an operation of the recording position deviation correction apparatus 101 will be described in detail.

The recording position deviation correction apparatus 101 includes the physical address position detection section 109, the physical address position storing section 110, the physical address position interval measuring section 111, the physical address position interpolation section 112, the sector top position detecting section 113, the recording position deviation correction and control section 114, and the recording position deviation correction section 115.

The physical address position detection section 109 detects the physical address signal which is embedded in the optical disc 100, from the signals of the reflected lights which are obtained from the optical head 103 during performing the recording and reproduction processing against the optical disc 100, and detects the position.

The physical address position storing section 110 stores the physical address that is detected by the physical address position detection section 109.

The physical address position interval measuring section 111 detects the interval between the continuous physical address positions. Here, the physical address position interval measuring section 111 detects the intervals between the physical address positions utilizing wobble signals which are included in the reflection light signals obtained from the optical head 103. This can be carried out by utilizing that wobble signals are periodic signals which are included in the reflection light signals that are obtained by irradiating a laser light for recording and reproduction to the optical disc 100, and that the periods of those would change according to the rotation speed of the optical disc 100, and the period numbers for respective physical address position intervals become constant irrespective of the rotation speed of the optical disc 100. In this way, the physical address position interval measuring section 111 can detect a correct physical address position interval by detecting the period numbers of the wobble signals.

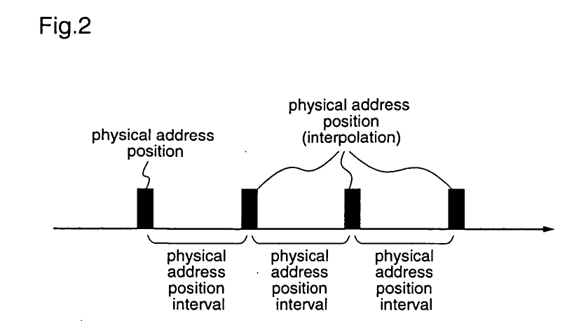

The physical address position interpolation section 112 interpolates the physical address position using the physical address position interval information that is obtained from the physical address position interval measuring section 111 on the basis of the physical address position information that is stored in the physical address position storing section 110. Here, FIG. 2 shows a diagram illustrating the interpolation processing for interpolating the physical address positions by the physical address interpolating section 112. As shown in FIG. 2, the physical address position interpolation section 112 repeatedly applies the physical address position intervals that are obtained from the physical address position interval measuring section 111 to the physical address position information that are obtained from the physical address position storing position 110, thereby obtaining desired physical addresses by interpolation.

The sector top position detecting section 113 detects the top position for each sector in the recording and reproduced data, and it detects the sector top position by detecting the synchronous signal of included in the recording and reproduced data. Further, the methods of detecting the sector top position at reproduction and at recording are different from each other. That is, the detection of the sector top position at reproduction is carried out by detecting the synchronization signal from the data signal included in the reflection light signal that is obtained from the optical head 103, while the detection of the sector top position at recording is carried out by detecting the synchronization signal from the data signal which is outputted from the modulation/demodulation signal 104.

The recording position deviation correction and control section 114 is constituted by, for example, a combination of a microcomputer and a program, and it detects the recording position deviation amount from the physical address position that is detected by performing an interpolation by the physical address position interpolation section using the physical address position before performing an additional recording processing that is stored in the physical address position storing section, at carrying out the additional recording processing continuously to the data region at which recording is already performed on the optical disc 100, and the sector top address that is detected at the sector top position detection section. Then, a signal indicating the recording deviation amount or a signal indicating the correction amount at the recording position deviation correction section 115 is generated as a signal indicating that the recording position deviation correction is to be carried out on the basis of the detected recording position deviation amount, and is outputted to the recording position deviation correction section 115.

The recording position deviation correction section 115 carries out recording position deviation correction so that the recording position deviation amount becomes zero on the basis of the signal outputted from the recording position correction and control section 114. As a measure for correcting the recording position deviation, there is, for example, a method of performing correction by compressing/expanding the synchronous signal included in the recorded data.

Next, an algorism for calculating a recording position deviation correction amount by the recording position deviation correction and control section 114 according to a first embodiment of the present invention will be described.

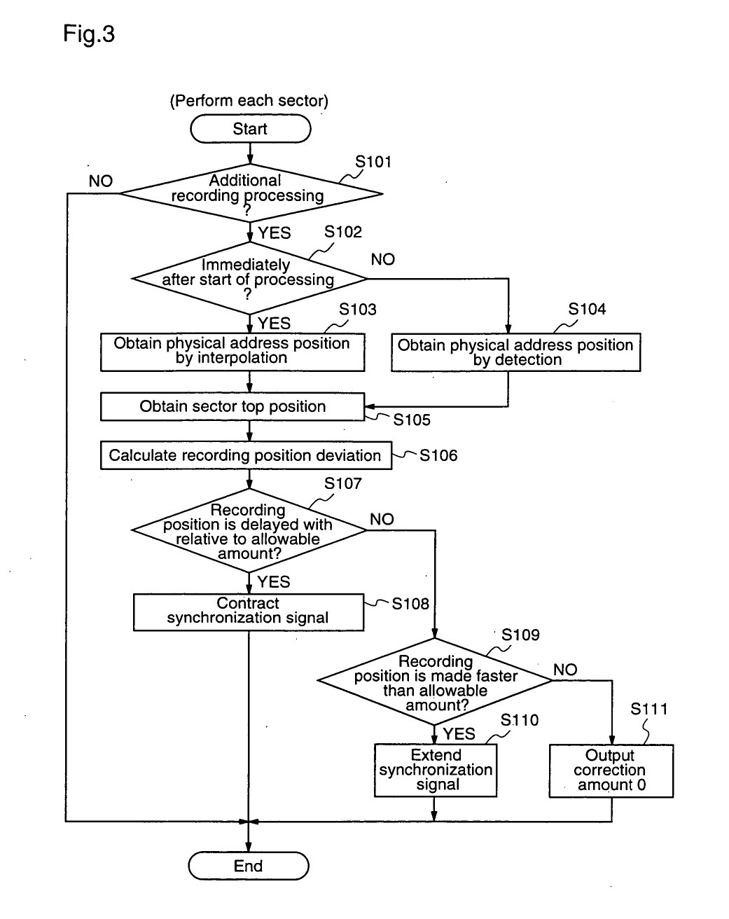

FIG. 3 is a flowchart illustrating a recording position deviation correction amount calculation algorism by the recording position deviation correction and control section 114 according to the first embodiment of the present invention. The present algorism is repeatedly carried out for each sector of the recording or reproduced data in the recording and reproduction processing.
(Step S101) First of all, the recording position deviation correction and control section 114 judges as to whether the recording processing under execution is an additional recording processing which carries out recording continuously to the data region where recording was already performed on the optical disc or not. Here, when the processing is not an additional recording processing, that is, it is an initial recording processing against the optical disc 100, no recording position deviation correction processing is performed.
(Step S102) Next, when the recording processing under execution is an additional recording processing, the recording position deviation correction and control section 114 judges whether it is immediately after the start of the additional recording processing or not. Particularly, the judgment as to whether it is immediately after the additional recording processing is started or not is conducted depending on whether the present processing is within N (N: an integer) sectors from the start point of the additional recording processing or not. The value N is set to an appropriate value for each execution. When it was immediately after the start of the additional recording processing as a result of judgment, it goes to step S103, while when it is not, it goes to step S104.
(Step S103) When it is judged as immediately after the additional recording processing as a result of the judgment in step S102, an interpolation processing is carried out by the physical address position interpolation section 112, to obtain the detected physical address. Here, as the physical address position information that is required in carrying out an interpolation processing by the physical address position interpolation section 112, a physical address position information that is detected before starting the additional recording processing, which is stored in the physical address position storing section 110 is employed. This is because since the obtaining of the physical address before executing the additional recording processing is a reproduction processing that is conducted with a constant laser intensity, it is possible to detect a physical address of a high reliability. By carrying out an interpolation processing from such a high reliability physical address before carrying out an additional recording processing, it is also possible to obtain a high reliability physical address even during performing the additional recording processing. Further, as the physical address position information before carrying out the additional recording processing, the physical address position information before carrying out the additional recording processing which is obtained at a position closest to the end of the recorded region among the physical address position information which are stored in the physical address position storing section 110 is adopted, in order to carry out an interpolation processing with as higher precision as possible.
(Step S104) On the other hand, when it is judges as it is not immediately after the start of the additional recording processing as a result of judgment in step S102, a physical address position corresponding to the present processing is obtained from the physical address position detection section 109 as in the prior art. Here, when it failed in acquiring the physical address position in the physical address position detection section 109 in the present step, the physical address position that is required in the present processing is obtained by performing an interpolation by the address position interpolation section 112 on the basis of the physical address position information that is closest to the present processing region among the physical address position information stored in the physical address position storing section 110 (including those under subjected to the additional recording processing).
(Step S105) Further, in step S105, the sector top position information is obtained from the sector top position detection section 113.
(Step S106) Next, the recording position deviation correction and control section 114 calculates the recording position deviation amount from the obtained physical address position information and the sector top position information. The recording position deviation amount is calculated by comparing the sector top position indicating the recording position in the present state and the physical address position serving as a reference in recording data into an optical disc 100, and then, it goes to step S107.
(Step S107, S108) It is judged as to whether the recording position is retarded with relative to the allowable amount of the recording position deviation amount on the basis of the recording position deviation amount that is calculated in step S106, and when the recording position is retarded with relative to the allowable amount, an instruction for correcting the recoding sector to be contracted so that the recording position deviation amount is gone, is issued to the recording position correcting section 115. Particularly, an instruction such as for making the synchronization signal contracted is thought of. Further, when the recording position is not delayed with relative to the allowable amount, it goes to step S109.
(Step S109, S110) In step S109, it is judged as to whether the recording position is positioned front with relative to the allowable amount of the recording position deviation amount on the basis of the recording position deviation amount calculated in step S106, and when the recording position is positioned front with relative to the allowable amount, it instructs the recording position deviation correction section 115 to perform correction to extend the recording sector so that the recording position deviation amount is gone. Particularly, such as an instruction for extending the synchronization signal is thought of.
(Step S111) Further, when the recording position deviation is within the allowable range, a signal indicating that the recording position deviation correction is not to be performed is outputted to the recording position deviation correction section 115.

As described above, the recording position deviation correction apparatus of the first embodiment of the present invention performs an interpolation processing on the basis of the high reliability physical address that is detected before executing the additional recording processing, without detecting the physical address from an optical disc, at carrying out the additional recording processing which carries out recording of data continuously to the data region where the recording is already performed on an optical disc, to detect the physical address position during the additional recording processing, and therefore, it is possible to obtain a high reliability physical address position, and it is possible to carry out a high quality recording position deviation correction.

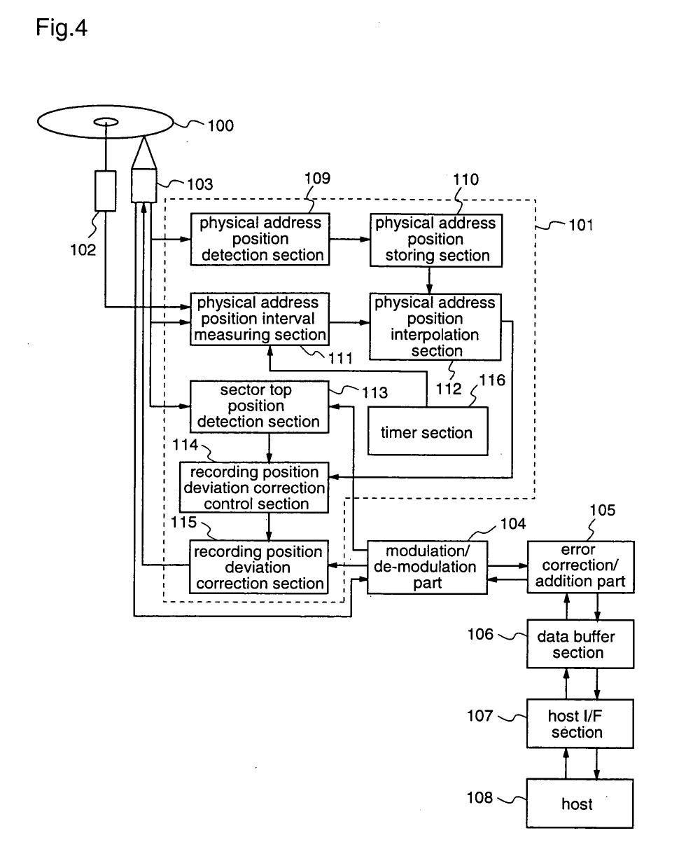

Besides, while in the recording position deviation correction apparatus according to the first embodiment, the physical address position interval is detected by detecting the period number for each physical address position interval of the wobble signals in the physical address position interval measuring section 111, the physical address position interval measuring section 111 may be provided with a timer section 116, and the physical address position interval may be measured by using the timer section 116 as shown in FIG. 4. Particularly, since the distant interval between the physical addresses is known, the physical address position interval measuring section 111 may measure the detection intervals between the physical address positions may be measured using the timer section 116 on the basis of rotation speed information of the optical disc 100 that is obtained from the spindle motor 102.

### Embodiment 2

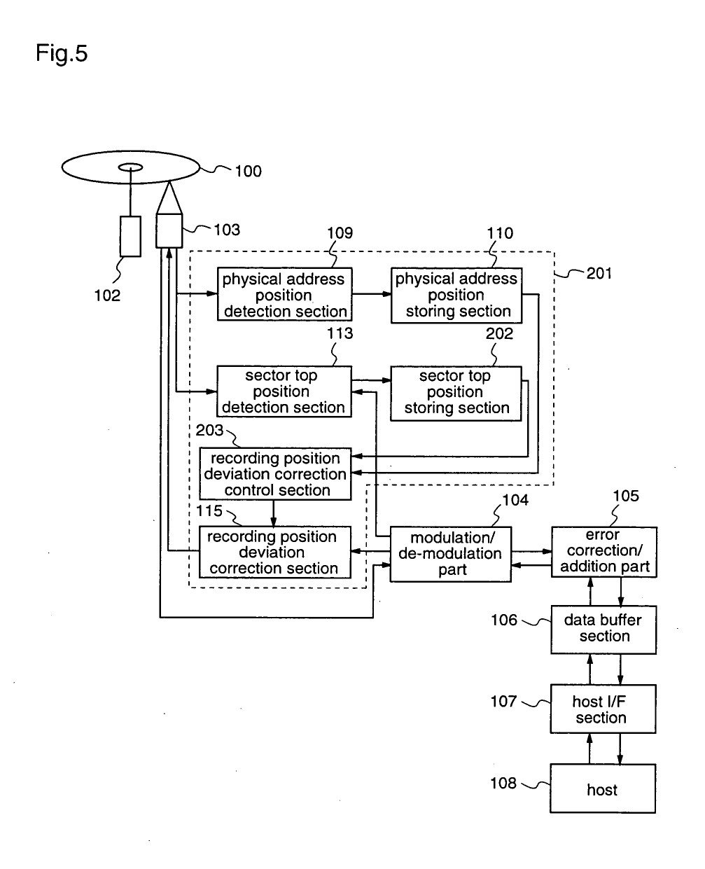

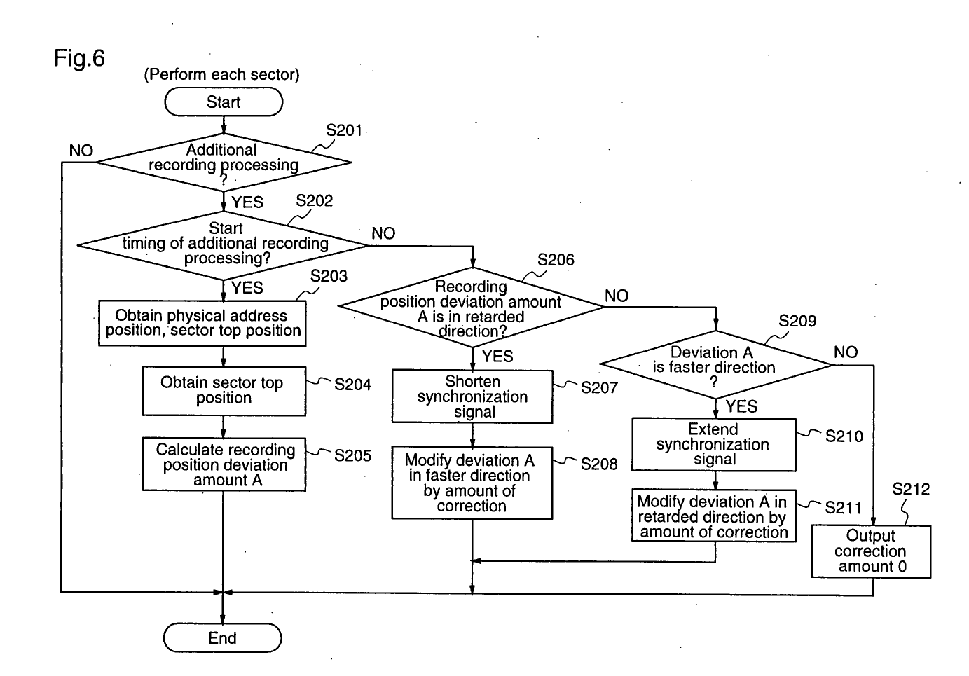

The recording position deviation correcting apparatus according to a second embodiment of the present invention functions to perform recording position deviation correction in the additional recording processing on the basis of the recording position deviation amount at the final sector in the recorded region that is calculated from the physical address position in the reproduction processing immediately before the additional recording processing and the sector top position corresponding thereto, at carrying out the additional recording processing which carries out recording of data continuously to the data region where the recording is already performed on an optical disc 100. The content thereof will be described with reference to FIGS. 5 and 6.

FIG. 5 is a diagram illustrating a whole construction of an optical disc apparatus according to the second embodiment of the present invention.

In FIG. 5, the optical disc apparatus of the second embodiment of the present invention includes a recording position deviation correction apparatus 201, a spindle motor 102, an optical head 103, a modulation/demodulation section 104, an error correction/addition section 105, a data buffer section 106, a host interface section 107, and a host 108. The components in the optical disc apparatus of this second embodiment similar to those in the optical disc apparatus of the first embodiment are denoted by the same reference numerals and the descriptions are omitted here.

The recording position deviation correction apparatus 201 corrects the recording position deviation in the continuing portion connecting the recorded region and the region where the additional recording processing is to be performed, on the basis of the position deviation amount between the SYNC position of the final sector in the recorded region and the corresponding physical address position, at carrying out an additional recording processing which carries out recording continuously to the data region where recording is already performed on the optical disc 100. Here, since the measurement of the position deviation amount in the recorded region can be carried out in the reproduction processing in which a laser light of a constant intensity is irradiated, it is possible to carry out detection of a high reliability physical address position and measurement of recording position deviation amount.

Hereinafter, the recording position deviation correction apparatus 201 will be described in detail.

The recording position deviation correction apparatus 201 includes the physical address position detection section 109, the physical address position storing section 110, the sector top position detection section 113, the recording position deviation correction section 115, the sector top position storing position 202, and the recording position deviation correction and control section 203. Here, the components in the recording position deviation correction apparatus 201 according to this second embodiment which are similar to those in the recording position deviation correction apparatus in the first embodiment are denoted by the same reference numerals and descriptions are omitted here.

The sector top position storing section 202 stores the sector top position which is detected by the sector top position detecting section 113.

The recording position deviation correction and control section 203 is constituted by a combination of such as a microcomputer and a program, and it detects the recording position deviation amount at the final sector in the recorded region from the physical address position immediately before the additional recording processing which is stored in the physical address position storing section 110 and the sector top position immediately before the additional recording processing which is stored in the sector top position storing section 202 at carrying out the additional recording processing which carries out recording continuously to the data region where the recording is already performed on the optical disc 100. Then, as a signal indicating to perform a recording position deviation correction on the basis of the detected recording position deviation amount, such as a signal indicating a recording position deviation amount or a correction amount at the recording position deviation correction section 115 is generated to be outputted to the recording position correction section 115.

Next, an algorism for calculating the recording position deviation correction amount by the recording position deviation correction control section 203 in the second embodiment of the present invention will be described with reference to FIG. 6.

FIG. 6 is a flowchart for explaining an algorism for calculating the recording position deviation correction amount in the recording position deviation correction control section 203 according to the second embodiment of the present invention. Here, the present algorism is carried out for each sector in the recording and reproduction processing.
(Step S201) First of all, the recording position deviation correction control section 203 judges as to where the recording processing under execution is an additional recording processing which carries out recording continuously to the data region where recording is already performed on an optical disc is not. When the processing is not an additional recording processing, i.e., it is an initial recording processing to be performed onto the optical disc 100, no recording position deviation correction processing is carried out.
(Step S202) Next, when the recording processing under execution is an additional recording processing, it is judged as to whether it is a start timing of the additional recording processing or not, and when it is the start timing of the additional recording processing, it goes to step S203, while when it is not a start timing, it goes to step S205.
(Step S203) Then, when the recording processing is at the start timing of the additional recording processing, as a physical address position information that is required for measuring the recording position deviation amount, the physical address position information that is detected immediately before the additional recording processing that is stored in the physical address position storing section 110 is obtained. On the other hand, when the recording processing is not at the start timing of the additional recording processing, it goes to step S206.

Besides, in the present embodiment, descriptions are given on an assumption that the physical address position immediately before the additional recording processing is stored in the physical address position storing section 110. However, by previously providing the physical address position interval measuring section 111 and the physical address position interpolation section 112 as described in the first embodiment using FIG. 1 in the recording position deviation correction apparatus, it is also possible to correspond to even a case where the physical address position immediately before the additional recording processing is not stored in the physical address position storing section 110 (caused by such as no detection). This is because it is possible to obtain the physical address position immediately before the additional recording processing by interpolating the physical addresses immediately before the additional recording processing on the basis of the physical address position information which is already stored in the physical address position storing section 110 by the physical address position interpolation section 112 when the physical address position immediately before the additional recording processing is not stored in the physical address position storing section 110.
(Step S204) Next, the sector top position corresponding to the physical address position that is obtained in the step S203 is obtained from the sector top position detection section 113.
(Step S205) Then, the recording position deviation correction and control section 203 calculates the recording position deviation amount A on the basis of the physical address position that is obtained in step S203 and the sector top position information that is obtained in step S204, and completes the processing.

Besides, in the present algorism, the recording deviation amount is calculated by the comparison between the physical address position and the sector top position only at a sector timing at starting the additional recording processing, and at subsequent timings for each sector in the additional recording processing, the processing of steps S206 to S212 are carried out on the basis of the recording position deviation amount A that is calculated in step S205.
(Step S206 to Step S208) When it is judged, as the result of judgment in step S205, the recording processing is not at the start timing of the additional recording processing, it is first judged as to whether the recording position deviation amount A that is calculated in step S205 is in a retarded direction or not, and when it is in the retarded direction, an instruction is issued for carrying out a correction for shortening the recording sector so that the recording position deviation amount is gone to the recording position deviation correction section 115. Here, such as an instruction for shortening the synchronization signal is thought of. Then, the recording position deviation amount A is modified in a fast direction by the amount corresponding to the correction processing, and the processing is completed. Further, when the recording position deviation amount A is not in the retarded direction, it goes to step S209.
(Step S209 to Step S211) Next, in step S210, it is judged whether the recording deviation amount A which is calculated in step S205 is a faster direction or not, and when it is in a faster direction, an instruction indicating make a correction for extending the recording sector so that the recording position deviation amount is gone is issued. More particularly, such as an instruction for extending the synchronization signal is thought of. Then, the recording position deviation amount A is modified to the retarding direction by the amount corresponding to the correction processing to be renewed, and completes the processing.
(Step S212) Further, when the recording position deviation A is zero, the recording position deviation correction is not carried out, and the recording correction amount 0 is outputted to the recording position deviation correction section 115.

As described above, the recording position deviation correction apparatus of the second embodiment of the present invention detects the recording position deviation amount at the final sector in the recorded region from the physical address position in the reproduction processing immediately before the additional recording processing and the sector top position corresponding thereto, without detecting the physical address position from the disc, at carrying out an additional recording processing which carries out recording continuously to the data region where the recording is already carried out on an optical disc, and carries out a recording position deviation correction on the basis if the detected recording position deviation amount immediately before the additional recording processing, thereby enabling detecting the recording position deviation amount at the final sector in the recorded region having a high reliability using the physical address that is detected in the reproduction processing immediately before the additional recording processing, whereby it is made possible to carry out a high quality recording position deviation correction with utilizing that the recording position deviation amount at the final sector in the recorded region and the position deviation amount which is to be corrected in the additional recording processing are approximately equal to each other.

### Embodiment 3

Next, a recording position deviation correction apparatus according to a third embodiment of the present invention additionally includes a laser control section 302 in the recording position deviation correction apparatus of the second embodiment, and it enables enhancing reliability in detection of the physical address position in the reproduction processing immediately before the additional recording processing.

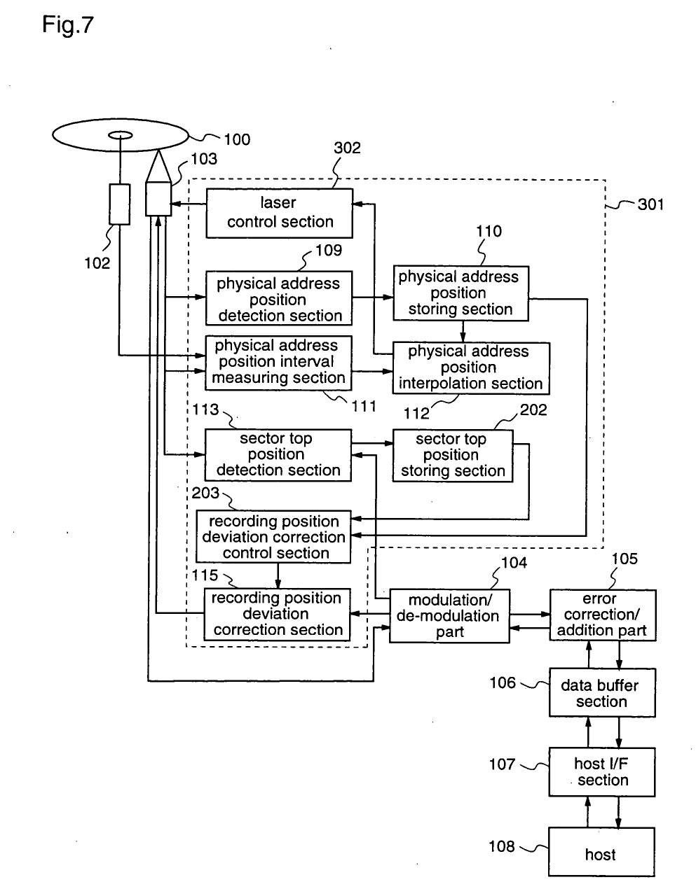

FIG. 7 is a block diagram illustrating the whole construction of the optical disc apparatus of the third embodiment.

In FIG. 7, the optical disc apparatus of the third embodiment of the present invention includes a recording position deviation correction apparatus 301, a spindle motor 102, an optical head 103, a modulation/demodulation section 104, an error correction/addition section 105, a data buffer section 106, a host interface section 107, and a host 108, and the recording position deviation correction apparatus 301 is constituted by a physical address position detection section 109, a physical address position storing section 110, a physical address position interval measuring section 111, a physical address position interpolation section 112, a sector top position detection section 113, a recording position deviation correction section 115, a laser control section 302, and a recording position deviation correction section 203. Besides, the components in the optical disc apparatus of this third embodiment similar to those in the optical disc apparatus of the first and the second embodiment are denoted by the same reference numerals and descriptions are omitted here.

The laser control section 302 included in the recording position correction apparatus 301 controls the laser output that is irradiated by the optical head 103, and controls the laser output irradiated by the optical head 103 so that data having a high physical address detection probability at reproduction is compulsorily recorded irregardless of the data to be recorded at the physical address detection timing at the final sector in the recording processing range. Here, generally, a space which has a high probability in detecting the physical address position at the reproduction processing is adopted to be recorded.

Besides, in this system, the adjustment of the laser power in the general recording and reproduction operation is carried out by the optical head 103.

Further, in the recording position deviation correcting apparatus 301 according to the third embodiment of the present invention, since a laser light of a constant intensity is compulsorily irradiated at a physical address detecting timing at the final sector in the recording processing range, a laser light of an intensity which does not correspond to the recorded data is irradiated onto an optical disc at a timing of detecting the physical address, thereby there may arise a possibility that an error data is included in the recorded data. However, an error correction processing which performs detection and correction of error data against the read out data is generally carried out. Therefore, even when a laser light of an intensity which does not correspond to the recorded data is irradiated at a physical address detection timing, it is possible to reproduce data that is equivalent to the recorded data by the way of the error correction function.

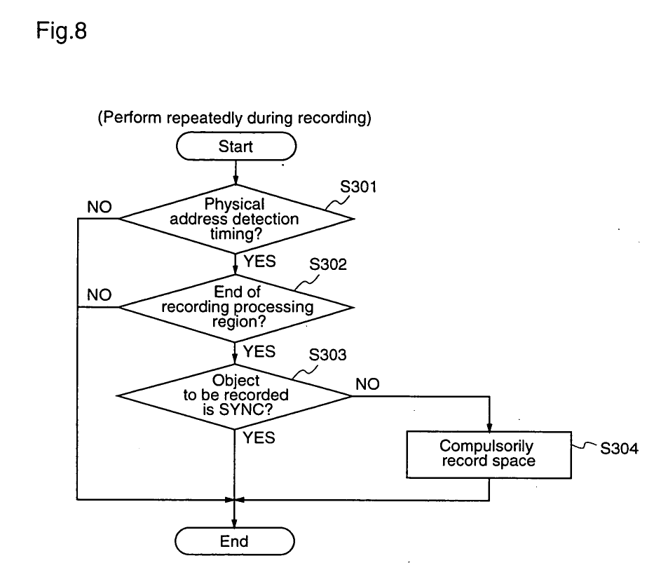

Next, the laser control algorism employed by the laser control section 302 in the third embodiment of the present invention will be described with reference to FIG. 8.

FIG. 8 is a flowchart for explaining the laser control algorism employed by the laser control section 302 in the third embodiment of the present invention. Here, the present algorism is always operating in the recording, and a series of operations from step S301 to step S304 are repeatedly carried out.
(Step S301) First of all, the laser control section 302 judges whether the present processing timing is a timing for detecting the physical address in the recording processing or not. Besides, the physical address detection timing can be known by interpolating the prior physical address positions using the physical address position information which are detected in the past and stored in the physical address position storing section 110 by the physical address position interpolation section 112.

Then, when it is judged as a physical address position detection timing, it goes to step S302, and when it is not the physical address position detection timing, no processing is performed, and the algorism is concluded.
(Step S302) Next, the laser control section 302 judges whether the present recording processing region is at the end of the recording processing range or not. More concretely, it is judged whether the present recording processing region is at the end of the recording processing region or not depending on whether the present processing region is within N (N: a positive integer) sectors from the final sector. Here, the value N can be arbitrarily set and it is set to an appropriate value in accordance with the specifications of the apparatus and the like.

When it is judged as the present recording processing region is at an end region, it goes to step S303, and when the present recording processing region is not at the end region, no processing is performed, and the algorism is completed.
(Steps S303, S304) Next, the laser control section 302 judges whether the object which is to be recorded into the optical disc 100 is a SYNC (synchronous signal) or not at the physical address detection timing.

When it is judges as not a SYNC signal, the laser control section 302 controls the optical head 103 so that a space is compulsorily recorded at the physical address detection timing. On the other hand, when it is judged as a SYNC (synchronous signal), no processing is performed, and the algorism is concluded.

As described above, according to the recording position deviation correction apparatus of the third embodiment of the present invention, a space which has a high physical address detection probability at the reproduction is recorded at the end region of the recording processing range by the laser control section 302, and thereby, the reliability in the physical address position detection in the reproduction processing immediately before the additional recording processing is enhanced.

Further, this apparatus enables detecting a correct recording position deviation amount at the final sector in the recorded region from the physical address position in the reproduction processing immediately before the additional recording processing and the sector top position corresponding thereto at carrying out the additional recording processing which carries out recording continuously to the data region where the recording s already performed on an optical disc, and thereby, it becomes possible to carry out a higher quality recording position deviation correction by the recording position deviation correction apparatus of the present invention.

### Embodiment 4

Next, a recording position deviation correction apparatus according to a fourth embodiment of the present invention includes a laser control section 402 which compulsorily irradiate the laser of an intensity that produces a high physical address detection probability at the physical address detection timing during the recording processing, and thereby makes it possible to enhance the reliability in detection of the physical address position during the recording processing.

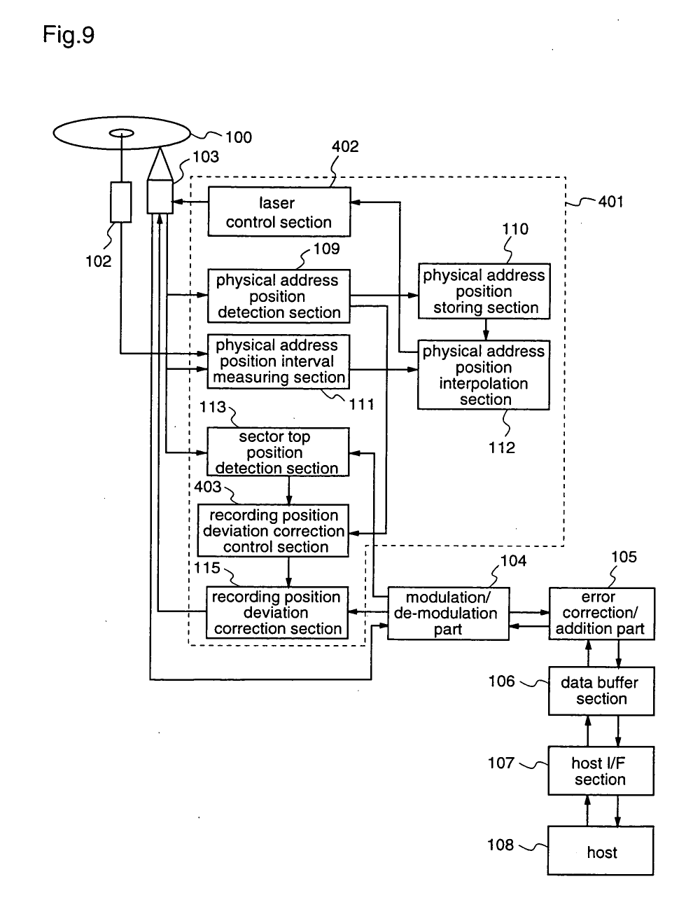

FIG. 9 is a block diagram illustrating a whole construction of an optical disc apparatus according to the fourth embodiment of the present invention.

In FIG. 9, the optical disc apparatus of the fourth embodiment of the present invention includes a recording position deviation correction apparatus 401, a spindle motor 102, an optical head 103, a modulation/de-modulation section 104, an error correction/addition section 105, a data buffer section 106, a host interface section 107, and a host 108. Here, the components similar to those in the first embodiment described above are assigned with the same numerals and descriptions are omitted here.

The recording position deviation correction apparatus 401 functions to compulsorily irradiate a laser of constant intensity at a detection timing of a physical address during the recording processing so that the level of the physical address signal may be constant, thereby to enhance the reliability in the physical address position detection in the recording processing, and then carries out a recording position correction from the detected physical address position and the sector top position of the recording and reproduction data. data.

In the recording position deviation correction apparatus 401 of the fourth embodiment of the present invention, since the laser of a constant intensity is compulsorily irradiated at the detection timing of the physical address during the recording processing, the laser of intensity which does not correspond to the recorded data would be irradiated to the optical disc at the detection timing of the physical address, thereby resulting in a possibility that error data are included in the recorded data. However, in the reproduction processing for reading out data in a disc, an error correction processing which carries out the detection and correction of error data is generally carried out to the data read out. Therefore, even when a laser of an intensity which does not correspond to the recorded data is irradiated at the timing of detecting the physical address, it is possible to reproduce data that is equivalent to the recorded data by the way of the error correction function.

Hereinafter, the recording position deviation correction apparatus 401 will be described in detail.

The recording position deviation correction apparatus 401 includes a physical address position detecting section 109, a physical address position storing section 110, a physical address position interval measuring section 111, a physical address interpolation section 112, a sector top position detecting section 113, a recording position deviation correcting section 115, a laser control section 402, and a recording position deviation correction and control section 403. Besides, in the recording position deviation correcting apparatus 401 of this fourth embodiment, the components similar to those in the recording position deviation correction apparatus 101 of the first embodiment are assigned with the same numerals and descriptions are omitted here.

The laser control section 402 functions to control the output of the laser which is irradiated by the optical head 103 and control the laser which is irradiated by the optical head 103 so that a laser having a high physical address detection probability is compulsorily irradiated irregardless of the recorded data at the detection timing of a physical address during the recording processing. Here, since the laser intensity at mark recording is generally stronger than that at the space recording in a disc recording processing, and the physical address signal level is also higher at mark recording accompanying therewith, it is controlled so that the laser control section 402 record marks at the detection timing of a physical address during the recording processing.

In the present system, the laser power adjustment in the general recording and reproduction operation is carried out by the optical head 103.

Further, the recording position deviation correction control section 403 is constituted, for example, by a combination of a microcomputer and a program, and it detects the recording position deviation amount from the physical address which is detected by the physical address position detecting section 109 from the light reflected from the laser light that is controlled by the laser control section 402, and the sector top position which is detected by the sector top position detection section 103. Then, as a signal indicating conducting recording position deviation correction on the basis of the detected recording position deviation amount, for example, a signal indicating the recording position correction amount, or a signal indicating a correction amount at the recording position deviation correction section 115 is generated, and is outputted to the recording position deviation section 115.

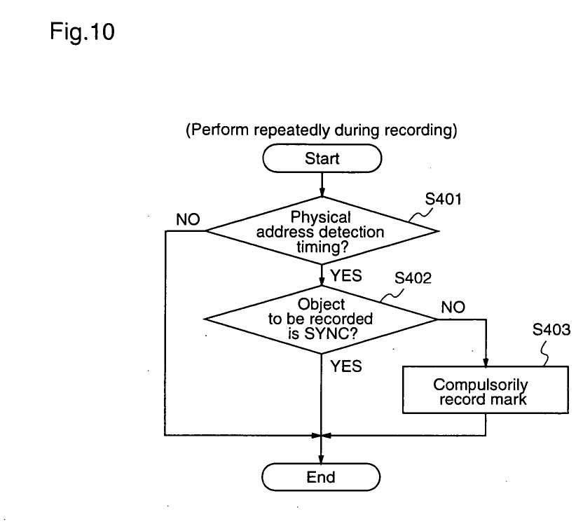

Next, a laser control algorism by the laser control section 402 according to the fourth embodiment of the present invention will be described with reference to FIG. 10.

FIG. 10 shows a flowchart for exemplifying the laser control algorism employed by the laser control section 402 in the fourth embodiment of the present invention. Besides, the present algorism is always operating in the recording, and a series of operations from step S401 to step S404 are repeatedly carried out.
(Step S401) First of all, the laser control section 402 judges whether the present processing timing is a timing for detecting the physical address in the recording processing or not. Besides, the physical address detection timing can be known by interpolating the prior physical address positions using the physical address position information which are detected in the past and stored in the physical address position storing section 110 by the physical address position interpolation section 112.

Then, when it is judged as a physical address position detection timing, it goes to step S402, and when it is not the physical address position detection timing, no processing is performed, and the algorism is concluded.
(Steps S402, S403) Next, the laser control section 402 judges whether the data which is to be recorded in an optical disc 100 is a SYNC (synchronous signal) or not at the physical address detection timing.

When it is judged as not a SYNC (synchronous signal), the laser control section 302 controls the optical head 103 so that marks are compulsorily recorded at the physical address detection timing. When it is judged as a SYNC (synchronous signal), no processing is performed, and the algorism is concluded.

As described above, according to the fourth embodiment of the present invention, a laser light having an intensity having a high physical address detection probability is compulsorily irradiated at the physical address detection timing during the recording processing, and thereby, the reliability of physical address position detection during the recording processing by the physical address position detection section 109 is enhanced, and a high quality recording position deviation correction can be carried out.

### Embodiment 5

A recording position deviation correcting apparatus according to a fifth embodiment of the present invention includes a physical address obtaining optical head which irradiates a laser light of a constant power which do not give any influences to the recording processing prior to the recording processing, and detects the physical address position using a reflection light which is received by the physical address obtaining optical head, thereby to detect a high reliability physical address position. By irradiating a laser of a constant intensity, a high reliability physical address position is detected.

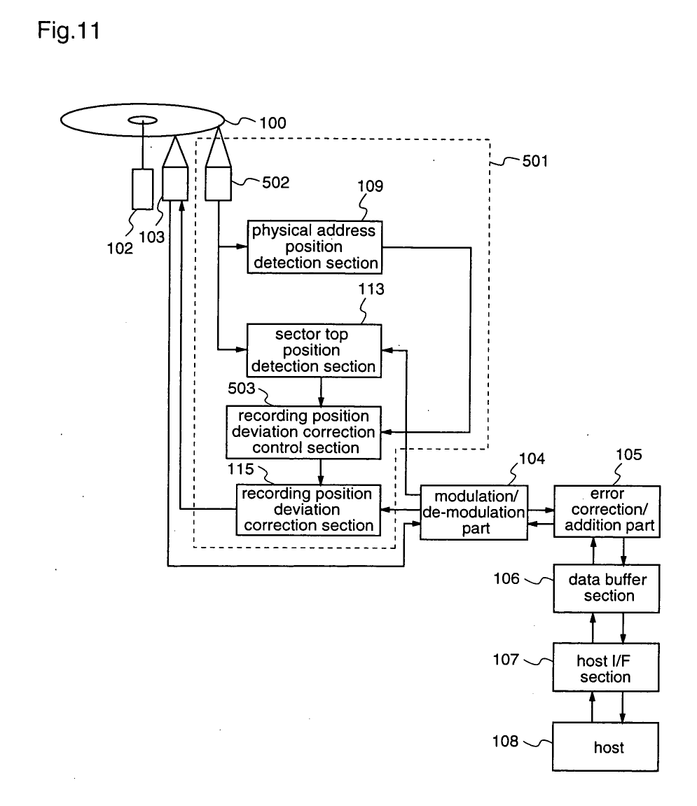

FIG. 11 is a block diagram showing a whole construction of an optical disc apparatus according to a fifth embodiment of the present invention.

In FIG. 11, the optical disc apparatus according to the fifth embodiment of the present invention includes a recording position deviation correction apparatus 501, a spindle motor 102, an optical head 103, a modulation/de-modulation section 104, an error correction/addition section 105, a data buffer section 106, a host interface section 107, and a host 108. Besides, in the optical disc apparatus of this fifth embodiment, the components similar to those in the optical disc apparatus of the first embodiment described above, are assigned with the same reference numerals and descriptions are omitted here.

The recording position deviation correcting apparatus 501 functions to irradiate a laser light of a constant intensity prior to the recording processing, so as to make the level of the detected physical address signal constant thereby to increase the reliability in the physical address position detection, and then carries out the recording position deviation correction in the additional recording processing from the detected physical address position and the sector top position of the recording and reproduction data.

Hereinafter, the recording position deviation correction apparatus 501 will be described in detail.

The recording position deviation correction apparatus 501 includes a physical address position detection section 109, a sector top position detection section 113, a physical address obtaining optical head 502, a recording position deviation correction and control section 503, and a recording position deviation correction section 115. Besides, in the recording position deviation correction apparatus 501 of the fifth embodiment of the present invention, the components similar to those in the recording position deviation correction apparatus 101 are assigned with the same reference numerals and descriptions are omitted here.

The physical address obtaining optical head 502 always irradiates a laser power for reproduction in both processing of recording and reproduction, and receives the reflected light. This block is mainly used for detecting the physical address position. Besides, the region where the physical address obtaining optical head 502 irradiates the laser light to the optical disc 100, is a region in front to the region where the laser is irradiated to the optical disc 100 by the optical head 103. Thereby, when the physical address is employed in a processing concerning the optical head 103, it is possible to utilize the physical address position which is obtained from the physical address obtaining optical head 502.

The recording position deviation correcting control section 503 is constituted by, for example, a combination of a microcomputer and a program, and it detects the recording position deviation amount from the physical address position that is detected by the physical address position detecting section 109 and the sector top position information that is detected by the sector top position detection section 113 both on the basis of the reflected light which is received by the physical address obtaining optical head 502 at carrying out the additional recording processing which carries out recording continuously to the data region where the recording is already performed on the optical disc 100. Then, as a signal indicating conducting recording position deviation correction on the basis of the detected recording position deviation amount, for example, a signal indicating the recording position deviation amount, or a signal indicating the correction amount at the recording position deviation correction section 115 is generated to be outputted to the recording position deviation correction section 115.

By such a construction, the physical address position detection circuit 109 can detect the physical address position using the reflection light obtained from the laser of a constant power, which is detected by the physical address obtaining optical head 502, and the recording position deviation correction control section 503 calculates the physical address deviation amount using the physical address position having a high reliability that is detected by the physical address position detection section 109 and the sector top position information that is detected by the sector top position detection section 113, and controls the recording position deviation correction section 115 so that the recording position deviation amount is gone.

As described above, according to the recording position deviation correction apparatus of the fifth embodiment of the present invention, there is provided a physical address obtaining optical head 502 which irradiates a laser power of a constant intensity, and the detection of the physical address position is carried out by only using a laser power of a constant intensity, thereby the detection of the physical address position can be carried out in a stationary state and a high reliability physical address position can be obtained, resulting in a high quality recording position deviation correction.

In the above-described fifth embodiment, a construction in which the physical address obtaining optical head 502 irradiates a laser power for reproduction is described. However, the laser power irradiated by the physical address obtaining optical head 502 is not limited thereto, and a laser power which does not give any influences on unrecorded regions on the recording medium may be employed.

In the respective embodiments of the present invention, the processing which are carried out by the recording position deviation correction apparatus and are explained with referring to the flowcharts shown in FIGS. 3, 6, 8, and 10 can be implemented by reciting the procedures described in the respective embodiments of the present invention in a program and making such as a central processing unit (CPU) of a personal computer execute the program. Further, such a program itself may be stored in various recording medium such as a semiconductor memory apparatus, or may be transmitted through a communication line such as an internet.

### APPLICABILITY IN INDUSTRY

The recording position deviation correction apparatus, the recording position deviation correction method, and the recording position deviation correction program according to the present invention are effective in being capable of performing a high quality recording position deviation correction at carrying out an additional recording processsing which performs recording continuosly to the data region where the recording is already performed on an optical disc.

1. A recoding position deviation correcting apparatus, comprising:
a physical address position detection section for detecting a physical address position which is embedded on an optical disc;
a physical address position storing section for storing the physical address positions which were detected by the physical address position detection section;
a physical address position interval measuring section for measuring the detection interval between the physical address positions which were detected by the physical address position detecting section;
a physical address position interpolating section for interpolating the physical address positions from the physical address position information which is stored in the physical address position storing section and the interval between the physical address positions which were measured by the physical address position interval measuring section;
a sector top position detection section for detecting the top position of the respective sectors in the data which were recorded in the optical disc;
a recording position deviation correction control section for detecting the recording position deviation amount from the physical address positions which were detected by the physical address position interpolation section using the physical address positions before performing additional recording processing which are stored in the physical address position storing section, and the sector top positions which were detected by the sector top position detection section, at carrying out an additional recording processing which records data continuously to the data region where the recording is already carried out on an optical disc, and generating a signal indicating to carry out recording position deviation correction based on the detected recording position deviation amount; and
a recording position deviation correction section for performing correction of the recording position of the data by the contraction/extension of the recording sector on the basis of the signal outputted from the recording position deviation correction control section.

2. A recording position deviation correction apparatus as defined in claim 1, wherein;
the physical address position interval measuring section measures the detection interval between the physical addresses on the basis of the wobble signals which are recorded on the optical disc.

3. A recording position deviation correction apparatus as defined in claim 1, wherein
the physical address position interval measuring section measures the detection interval between the physical positions using a timer section.

4. A recording position deviation correction apparatus, comprising:
a physical address position detection section for detecting a physical address position embedded on an optical disc;
a physical address position storing section for storing the physical address positions which were detected by the physical address position detection section;
a sector top position detection section for detecting the top position of the respective sectors in the data which are recorded in the optical disc;
a sector top position storing section for storing the sector top positions which were detected by the sector top position detection section;
a recording position deviation correction control section for detecting the recording position deviation amount from the physical address position immediately before the additional recording processing which is stored in the physical address position storing section and the sector top position immediately before the additional recording processing which is stored in the sector top position storing section, at carrying out the additional recording processing which records data continuously to the data region where the recording is already performed on an optical disc, and generating a signal indicating to carry out the recording position deviation correction based on the detected recording position deviation amount to output the same; and
a recording position deviation correction section for performing correction of the recording position of the data by the contraction/extension of the recording sector on the basis of the signal outputted from the recording position deviation correction control section.

5. A recording position deviation correction apparatus as defined in claim 4, further comprising:
a physical address position interval measuring section for measuring the detection interval between the physical address positions which were detected by the physical address position detecting section;
a physical address position interpolation section for interpolating the physical address positions from the physical address position information which is stored in the physical address position storing section and the interval between the physical address positions which were measured by the physical address position interval measuring section, to detect the physical address detection timing; and
a laser control section for controlling the output of the laser which is irradiated by the optical head so that the data which has a high physical address position detection probability at the reproduction irregardless of the data to be recorded, at a physical address detection timing that is detected by the physical address position interpolation section at final several sectors in the recording processing range.

6. A recoding position deviation correcting apparatus as defined in claim 5, wherein
the laser control section controls the output of the laser which is irradiated by an optical head so that a space is recorded irregardless of the data to be recorded, at the physical address detection timing at the final several sectors in the recording processing range.

7. A recording position deviation correction apparatus, comprising:
a laser control section for controlling the output of a laser which is irradiated by an optical head so that a laser light which has a high physical address detection probability irregardless of the data to be recorded is irradiated, at the physical address detection timing during the recording processing;
a physical address position detection section for detecting a physical address position which is embedded on an optical disc;
a physical address position storing section for storing the physical address position which was detected by the physical address position detection section;
a physical address position interval measuring section for measuring the detection interval between the physical address positions which were detected by the physical address position detecting section;
a physical address position interpolating section for interpolating the physical address positions from the physical address position information which is stored in the physical address position storing section and the interval between the physical address positions which were measured by the physical address position interval measuring section, to detect the physical address detection timing;
a sector top position detection section for detecting the top position of the respective sectors in the data which are recorded in the optical disc;
a recording position deviation correction control section for detecting the recording position deviation amount from the physical address positions which were detected by the physical address position detection section from the reflected light caused by the laser light that is controlled by the laser control section and the sector top positions which were detected by the sector top position detection section, at carrying out the additional recording processing which records data continuously to the data region where the recording is already performed on an optical disc, and generates a signal indicating to carry out recording position deviation correction based on the detected recording position deviation amount; and
a recording position deviation correction section for performing correction of the recording position of the data by contraction/extension of the recording sector on the basis of the signal outputted from the recording position deviation correction control section.

8. A recoding position deviation correcting apparatus as defined in claim 7, wherein
the laser control section controls the optical head so that the laser of a power for a mark is irradiated irregardless of the data to be recorded, at the physical address detection timing during the recording processing.

9. A recording position deviation correction apparatus, comprising:
a physical address obtaining optical head for irradiating a laser of a constant power which does not influence on the recording processing, prior to irradiating the laser for performing a recording processing;
a physical address position detection section for detecting the physical address which is embedded on the optical disc from the reflection light which is received by the physical address obtaining head;
a sector top position detection section for detecting the top position of the respective sectors in the data which are recorded in the optical disc;
a recording position deviation correction control section for detecting the recording position deviation amount from the physical address position that is detected by the physical address position detection section and the sector top position that is detected by the sector top position detection section, at carrying out the additional recording processing which records the data continuously to the data region where the recording is already performed an optical disc, and generating a signal indicating to carry out recording position deviation correction based on the detected recording position deviation amount; and
a recording position deviation correction section for performing correction of the recording position of the data by the contraction/extension of the recording sector on the basis of the signal outputted from the recording position deviation correction control section.

10. A recoding position deviation correcting apparatus as defined in claim 9, wherein
the physical address obtaining optical head always irradiates the laser power at the data reproduction.

11. A recording position deviation correction method, comprising:
a physical address position detection step for detecting a physical address position which is embedded on an optical disc;
a physical address position storing step for storing the physical address position which is detected by the physical address position detection step;
a physical address position interval measuring step for measuring the detection interval between the physical address positions which are detected by the physical address position detecting step;
a physical address position interpolating step for interpolating the physical address positions from the physical address position information which is stored in the physical address position storing step and the interval between the physical address positions which was measured by the physical address position interval measuring step;
a sector top position detection step for detecting the top position of the respective sectors in the data which is recorded in the optical disc;
a recording position deviation correction control step for detecting the recording position deviation amount from the physical address position which is detected by the physical address position interpolation step using the physical address position before performing additional recording processing which was stored in the physical address position storing step, and the sector top position which is detected by the sector top position detection step, at carrying out an additional recording processing which records data continuously to the data region where the recording is already performed on an optical disc, and generates a signal indicating to carry out recording position deviation correction based on the detected recording position deviation amount; and
a recording position deviation correction step for performing correction of the recording position of the data by contraction/extension of the recording sector on the basis of the signal outputted from the recording position deviation correction control step.

12. A recording position deviation correction method, comprising:
a physical address position detection step for detecting a physical address position embedded on an optical disc;
a physical address position storing step for storing the physical address position which is detected by the physical address position detection step;
a sector top position detection step for detecting the top position of the respective sectors in the data which are recorded in the optical disc;
a sector top position storing step for storing the sector top position that is detected by the sector top position detection step;
a recording position deviation correction control step for detecting the recording position deviation amount from the physical address position immediately before the additional recording processing which was stored in the physical address position storing step, and the sector top position immediately before the additional recording processing which was stored in the sector top position storing step, at carrying out an the additional recording processing which records data continuously to the data region where the recording is already performed on an optical disc, and generates a signal indicating to carry out recording position deviation correction based on the detected recording position deviation amount; and
a recording position deviation correction step for performing correction of the recording position of the data by contraction/extension of the recording sector on the basis of the signal outputted from the recording position deviation correction control step.

13. A recording position deviation correction method as defined in claim 12, wherein
a physical address position interval measuring section for measuring the detection interval between the physical address positions which were detected by the physical address position detecting step;
a physical address position interpolation step for interpolating the physical address positions from the physical address position information which was stored in the physical address position storing step and the interval between the physical address positions which was measured by the physical address position interval measuring step, thereby to detect the physical address detection timing; and
a laser control step for controlling the laser output which is irradiated by the optical head, so that data which has a high physical address detection probability at the reproduction regardless of the recording data are recorded, at the physical address detection timing at the final several sectors within the recording processing range.

14. A recording position deviation correction method, comprising:
a laser control section for controlling the output of a laser which is irradiated by an optical head, so that data which has a high physical address detection probability at the reproduction regardless of the recording data are recorded, at the physical address detection timing during the recording processing;
a physical address position detection step for detecting a physical address position embedded on an optical disc;
a physical address position storing step for storing the physical address position which was detected by the physical address position detection step;
a physical address position interval measuring step for measuring the detection interval between the physical address positions which are detected by the physical address position detecting step;
a physical address position interpolation step for interpolating the physical address positions from the physical address position information which was stored in the physical address position storing step and the interval between the physical address positions, which was measured by the physical address position interval measuring step, to detect the physical address detection timing;
a sector top position detection step for detecting the top position of the respective sectors in the data which are recorded in the optical disc;
a recording position deviation correction control step for detecting the recording position deviation amount from the physical address position which was detected in the physical address position detection step from the reflected light caused by the laser light that is controlled by the laser control step, and the sector top position that is detected by the sector top position detection step, at carrying out the additional recording processing which records data continuously to the data region where the recording is already performed on an optical disc, and generating a signal indicating to carry out recording position deviation correction based on the detected recording position deviation amount; and
a recording position deviation correction step for carrying out correction of the recording position of the data by contraction/extension of the recording sector on the basis of the signal outputted in the recording position deviation correction control step.

15. A recording position deviation correction method, comprising:
a physical address position detection step for detecting the physical address which is embedded on the optical disc from the reflection light that is obtained by irradiating a laser of a power which does not influence on the recording processing, prior to irradiating the laser for performing a recording processing;
a sector top position detection step for detecting the top position of the respective sectors in the data recorded in the optical disc;
a recording position deviation correction control step for detecting the recording position deviation amount from the physical address position which was detected in the physical address position detection step and the sector top position that was detected in the sector top position detection step, at carrying out the additional recording processing which records data continuously to the data region where the recording is already performed on an optical disc, and generating a signal indicating to carry out recording position deviation correction based on the detected recording position deviation amount; and
a recording position deviation correction step for performing correction of the recording position of the data by contraction/extension of the recording sector on the basis of the signal outputted in the recording position deviation correction control step.

16. A recording position deviation correction program, making a computer execute:
a physical address position detection step for detecting a physical address position which is embedded on an optical disc;
a physical address position storing step for storing the physical address position which was detected in the physical address position detection step;
a physical address position interval measuring step for measuring the detection interval between the physical address positions which were detected in the physical address position detecting step;
a physical address position interpolation step for interpolating the physical address positions from the physical address position information which is stored in the physical address position storing step and the interval between the physical address positions, which was measured in the physical address position interval measuring step;
a sector top position detection step for detecting the top position of the respective sectors in the data which are recorded in the optical disc;
a recording position deviation correction control step for detecting the recording position deviation amount from the physical address position which was detected in the physical address position interpolation step and the sector top position which is detected in the sector top position detection step, using the physical address position before performing additional recording processing which was stored in the physical address position storing step, at carrying out the additional recording processing which records data continuously to the data region where the recording is already performed on an optical disc, and generating a signal indicating to carry out recording position deviation correction based on the detected recording position deviation amount; and
a recording position deviation correction step for performing correction of the recording position of the data by contraction/extension of the recording sector on the basis of the signal outputted from the recording position deviation correction control step.

17. A recording position deviation correction program, making a computer execute:
a physical address position detection step for detecting a physical address position which is embedded on an optical disc;
a physical address position storing step for storing the physical address position which was detected in the physical address position detection step;
a sector top position detection section for detecting the top position of the respective sectors in the data which is recorded in the optical disc;
a sector top position storing step for storing the sector top position that is detected by the sector top position detection step;
a recording position deviation correction control step for detecting the recording position deviation amount from the physical address position immediately before the additional recording processing which is stored in the physical address position storing step and the sector top position immediately before the additional recording processing which is stored in the sector top position storing step, at carrying out the additional recording processing which records data continuously to the data region where the recording is already performed on an optical disc, and generating a signal indicating to carry out recording position deviation correction based on the detected recording position deviation amount; and
a recording position deviation correction step for performing correction of the recording position of the data by contraction/extension of the recording sector on the basis of the signal outputted from the recording position deviation correction control step.

18. A recording position deviation correction program as defined in claim 17, which further makes a computer operate:
a physical address position interval measuring step for measuring the detection interval between the physical address positions which were detected in the physical address position detecting step;
a physical address position interpolation step for interpolating the physical address positions from the physical address position information which was stored in the physical address position storing step and the interval between the physical address positions which were measured in the physical address position interval measuring step, thereby to detect the physical address detection timing; and
a laser control step for controlling the output of the laser which is irradiated by the optical head, so that data which has a high physical address detection probability at the reproduction are recorded irregardless of the data to be recorded, at the physical address detection timings which were detected in the physical address position interpolation step at the final several sectors in the recording processing range.

19. A recording position deviation correction program, which makes a computer execute:
a laser control step for controlling the output of a laser which is irradiated by an optical head, so that a laser which has a high physical address detection probability is irradiated irregardless of the data to be recorded, at the physical address detection timings during the recording processing;
a physical address position detection step for detecting a physical address position which is embedded on an optical disc;
a physical address position storing step for storing the physical address position which was detected in the physical address position detection step;
a physical address position interval measuring step for measuring the detection interval between the physical address positions which are detected by the physical address position detecting step;
a physical address position interpolation step for interpolating the physical address positions from the physical address position information which was stored in the physical address position storing step and the interval between the physical address positions, which were measured by the physical address position interval measuring step, thereby to detect the physical address detection timings;
a sector top position detection step for detecting the top positions of the respective sectors in the data which are recorded in the optical disc;
a recording position deviation correction control step for detecting the recording position deviation amount from the physical address positions which were detected from the reflected light that is caused by the laser light controlled by the laser control step in the physical address position detection step, and the sector top position that was detected in the sector top position detection step, at carrying out the additional recording processing which records data continuously to the data region where the recording is already performed on an optical disc, and generating a signal indicating to carry out recording position deviation correction based on the detected recording position deviation amount; and
a recording position deviation correction step for performing correction of the recording position of the data by contraction/extension of the recording sector on the basis of the signal outputted from the recording position deviation correction control step.

20. A recording position deviation correction program, which makes a computer execute:
a physical address position detection step for detecting the physical address which is embedded on the optical disc from the reflection light that is obtained by irradiating a laser of a power which does not influence on the recording processing, prior to irradiating the laser for performing a recording processing;
a sector top position detection step for detecting the top position of the respective sectors in the data which are recorded in the optical disc;
a recording position deviation correction control step for detecting the recording position deviation amount from the physical address positions which were detected in the physical address position detection step, and the sector top position which was detected in the sector top position detection step, at carrying out the additional recording processing which records data continuously to the data region where the recording is already performed on an optical disc, and generating a signal indicating to carry out recording position deviation correction based on the detected recording position deviation amount; and
a recording position deviation correction step for correcting the recording position of data by contraction/extension of the recording sector, on the basis of the signal that is obtained in the recording position deviation correction control step.
